(19) United States
(12) Patent Application Publication
(10) Pub. No.: US 2015/0029634 A1
(43) Pub. Date: Jan. 29, 2015

(54) NETWORK SIGNAL PROCESSING CIRCUIT

(71) Applicant: Lotes Co., Ltd, Keelung (TW)

(72) Inventor: Shan Ju Yang, Keelung (TW)

(73) Assignee: Lotes Co., Ltd, Keelung (TW)

(21) Appl. No.: 14/076,699

(22) Filed: Nov. 11, 2013

(30) Foreign Application Priority Data
Jul. 29, 2013 (CN) 201320454749.4

(51) Int. Cl. H02H 9/04

(52) U.S. Cl. CPC H02H 9/045
USPC 361/119

(57) ABSTRACT

A network signal processing circuit includes at least one transmission line and at least two transient voltage suppressors. The transmission line has a first connection end and a second connection end. Each of the transient voltage suppressors is connected between a grounding point and a node on the transmission line. Two of the transient voltage suppressors are connected in parallel. A micro resistor is connected in series on the line where each of the transient voltage suppressors is located. By using the micro resistors connected in series on the lines where the two transient voltage suppressors connected in parallel are located, an overcurrent in a lightning signal can be diverted through the two transient voltage suppressors connected in parallel.

### CROSS-REFERENCE TO RELATED APPLICATION

This non-provisional application claims priority under 35 U.S.C. §119(a) on Patent Application No. 201320454749.4 filed in P.R. China on Jul. 30, 2013, the entire contents of which are hereby incorporated by reference.

Some references, if any, which may include patents, patent applications and various publications, may be cited and discussed in the description of this invention. The citation and/or discussion of such references, if any, is provided merely to clarify the description of the present invention and is not an admission that any such reference is “prior art” to the invention described herein. All references listed, cited and/or discussed in this specification are incorporated herein by reference in their entireties and to the same extent as if each reference was individually incorporated by reference.

### FIELD OF THE INVENTION

The present invention relates generally to a network signal processing circuit, and more particularly to a network signal processing circuit having a lightening protection function.

### BACKGROUND OF THE INVENTION

Communication between a registered jack (RJ) electrical connector and a network chip is achieved through a network signal processing circuit. The RJ electrical connector is prone to lightning strikes during thunderstorms, and a lightning signal easily enters the network chip through the network signal processing circuit, which causes damage to the network chip, affecting communication between the network chip and external electronic elements.

Therefore, a heretofore unaddressed need exists in the art to address the aforementioned deficiencies and inadequacies.

### SUMMARY OF THE INVENTION

In one aspect, the present invention is directed to a network signal processing circuit having a good lightening protection function.

In one embodiment, a network signal processing circuit includes at least one transmission line and at least two transient voltage suppressors. The transmission line has a first connection end and a second connection end. Each of the transient voltage suppressors is connected between a grounding point and a node on the transmission line. Two of the transient voltage suppressors are connected in parallel. A micro resistor is connected in series on the line where each of the transient voltage suppressors is located.

In one embodiment, the micro resistor is connected in series between an anode of the transient voltage suppressor and the grounding point.

In a preferred embodiment, the network signal processing circuit includes more than one pair of the transmission lines. A common-mode filtering unit is further connected in series to each pair of the transmission lines. One end of the common-mode filtering unit is connected to the second connection end, and the other end of the common-mode filtering unit is connected to the node.

In one embodiment, an attenuation unit is further connected in series to each of the transmission lines at a position adjacent to the first connection end. Specifically, the attenuation unit is a resistor.

In one embodiment, a matching unit is further connected in series to each of the transmission lines at a position adjacent to the first connection end. The matching unit includes a coupling capacitor and a TVS diode having an internal parasitic capacitance. The coupling capacitor is connected in series between the node and the attenuation unit. One end of the TVS diode is connected to the transmission line, and the other end of the TVS diode is grounded.

Further, the first connection end is connected to a network chip, and the second connection end is connected to an RJ45 socket. A rectifier bridge is further connected between a cathode of each of the transient voltage suppressors and the node.

In one embodiment, the micro resistor may be connected in series between a cathode of the transient voltage suppressor and the node.

In one embodiment, the matching unit includes a coupling capacitor and a compensation capacitor. The coupling capacitor is connected in series between the node and the attenuation unit, and two ends of the compensation capacitor are respectively connected to the transmission line and the grounding point.

As compared with related art, in certain embodiments of the present invention, by using the micro resistors connected in series on the lines where the two transient voltage suppressors connected in parallel are located, an overcurrent in a lightning signal can be diverted through the two transient voltage suppressors connected in parallel, which can not only provide protection against lightning, but can also prevent the transient voltage suppressor that breaks down first from burning out due to the overcurrent, thereby ensuring the stability and durability of the transient voltage suppressors.

These and other aspects of the present invention will become apparent from the following description of the preferred embodiment taken in conjunction with the following drawings, although variations and modifications therein may be effected without departing from the spirit and scope of the novel concepts of the disclosure.

### BRIEF DESCRIPTION OF THE DRAWINGS

The accompanying drawings illustrate one or more embodiments of the invention and together with the written description, serve to explain the principles of the invention. Wherever possible, the same reference numbers are used throughout the drawings to refer to the same or like elements of an embodiment.

FIG. 1 is a structural block diagram of a network signal processing circuit according to a first embodiment of the present invention.

FIG. 2 is a circuit diagram illustrating the principles of the network signal processing circuit according to the first embodiment of the present invention.

FIG. 3 is a detailed circuit diagram illustrating the principles of a network signal processing circuit according to a second embodiment of the present invention.

FIG. 4 is a schematic diagram of current flow directions of lightening protection units in two pairs of transmission lines in FIG. 3.

FIG. 5 is a schematic diagram illustrating diversion of a current in a lightning signal in FIG. 4.

FIG. 6 is a partial circuit diagram illustrating the principles of a network signal processing circuit according to a third embodiment of the present invention.

### DETAILED DESCRIPTION OF THE INVENTION

The present invention is more particularly described in the following examples that are intended as illustrative only since numerous modifications and variations therein will be apparent to those skilled in the art. Various embodiments of the invention are now described in detail. Referring to the drawings, like numbers indicate like components throughout the views. As used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise. Moreover, titles or subtitles may be used in the specification for the convenience of a reader, which shall have no influence on the scope of the present invention.

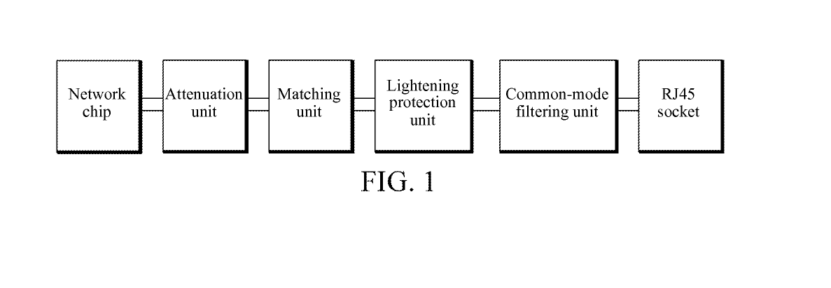

FIG. 1 shows a network signal processing circuit according to a first embodiment of the present invention, which is used for connecting a network chip and an RJ45 socket, and includes a common-mode filtering unit, a lightening protection unit, a matching unit and an attenuation unit in sequence from right to left. In other embodiments, the positions of the matching unit and the attenuation unit are interchangeable.

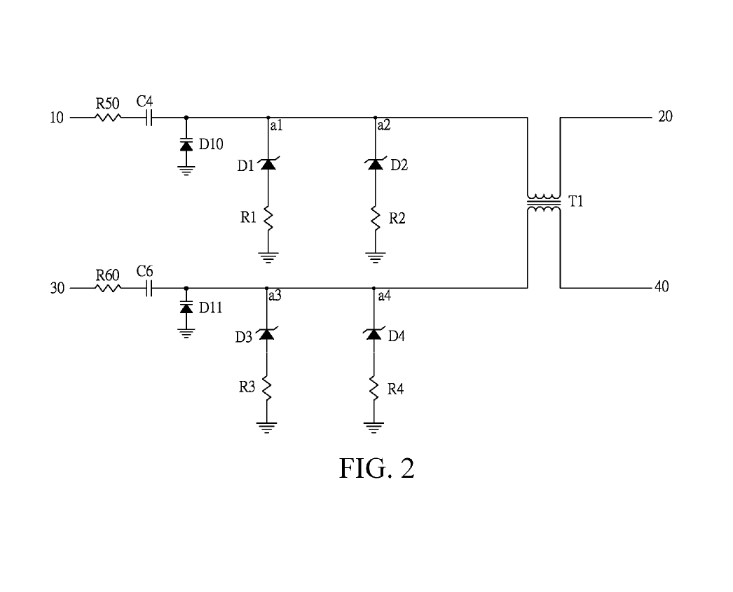

FIG. 2 is a circuit diagram illustrating the principles of the first embodiment, including two transmission lines connected in parallel. A first transmission line in the upper part has a first connection end 10 and a second connection end 20, and a second transmission line in the lower part has a first connection end 30 and a second connection end 40.

First, the lightening protection unit is introduced. Referring to FIG. 2, there are two nodes a1 and a2 on the first transmission line. One end of a transient voltage suppressor D1 is connected to the node a1, and one end of a transient voltage suppressor D2 is connected to the node a2. A micro resistor R1 is connected in series between an anode of the transient voltage suppressor D1 and a grounding point, and a micro resistor R2 is connected in series between an anode of the transient voltage suppressor D2 and a grounding point, so that a parallel connection is formed between the two transient voltage suppressors D1 and D2. In this embodiment, the micro resistors R1 and R2 are surface mount resistor elements. In other embodiments, the micro resistors may be formed by using resistance properties of the transmission line.

Next, the common-mode filtering unit is introduced. Referring to FIG. 2, in this embodiment, a pair of lines formed by the first transmission line and the second transmission line is further connected in series to a common-mode filter T1. Two ends of a coil of the common-mode filter T1 are respectively connected to the second connection end 20 and the node a2, and two ends of the other coil of the common-mode filter T1 are respectively connected to the second connection end 40 and a node a4.

Finally, the matching unit and the attenuation unit are introduced. Referring to FIG. 2, the matching unit and the attenuation unit are further connected on the first transmission line at positions adjacent to the first connection end 10. The attenuation unit is a resistor R50 connected in series on the first transmission line. The matching unit includes a coupling capacitor C4 and a TVS diode D10 having an internal parasitic capacitance. The coupling capacitor C4 is connected in series on the first transmission line. An anode of the TVS diode D10 is grounded, and a cathode of the TVS diode D10 is connected to the first transmission line.

Elements on the second transmission line in the lower part and connection relationships thereof are the same as those on the first transmission line, so the details will not be described herein again.

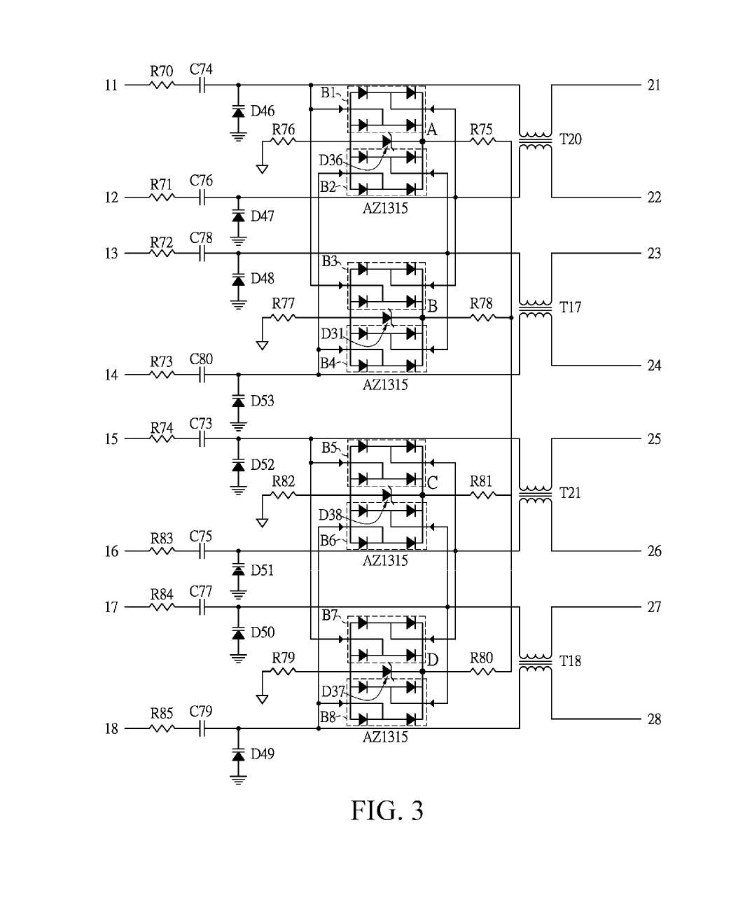

In a preferred embodiment, FIG. 3 is a detailed circuit diagram illustrating the principles of a network signal processing circuit according to a second embodiment. The network signal processing circuit includes four pairs of transmission lines, that is, a total of eight transmission lines. The transmission lines have first connection ends 11-18 on the left and second connection ends 21-28 on the right. The first connection ends 11-18 are connected to the network chip, the second connection ends 21-28 are connected to the RJ45 socket. The first connection ends 11-18 and the second connection ends 21-28 may both be used as input and output ends.

Referring to FIG. 1 and FIG. 3, the common-mode filtering unit on a first pair of transmission lines is a common-mode filter T20, which is connected in series to the first pair of transmission lines. One end of two coils of the common-mode filter T20 is respectively connected to the second connection ends 21 and 22, and the other end of the two coils of the common-mode filter T20 is respectively connected to input ends of rectifier bridges B1 and B2. Output ends of the rectifier bridges B1 and B2 are connected to a cathode of a transient voltage suppressor (TVS) D36. A micro resistor R76 is connected in series between an anode of the transient voltage suppressor D36 and the grounding point. In addition, the anode of the transient voltage suppressor D36 is further connected to one end of a resistor R75.

Likewise, the common-mode filtering unit on the second pair of transmission lines is a common-mode filter T17, which is connected in series to the second pair of transmission lines. One end of two coils of the common-mode filter T17 is respectively connected to the second connection ends 23 and 24, and the other end of the two coils of the common-mode filter T17 is respectively connected to input ends of rectifier bridges B3 and B4. Output ends of the rectifier bridges B3 and B4 are connected to a cathode of a transient voltage suppressor (TVS) D31. A micro resistor R77 is connected in series between an anode of the transient voltage suppressor D31 and the grounding point. In addition, the anode of the transient voltage suppressor D31 is further connected to one end of a resistor R78.

The common-mode filtering unit on the third pair of transmission lines is a common-mode filter T21, which is connected in series to the third pair of transmission lines. One end of two coils of the common-mode filter T21 is respectively connected to the second connection ends 25 and 26, and the other end of the two coils of the common-mode filter T21 is respectively connected to input ends of rectifier bridges B5 and B6. Output ends of the rectifier bridges B5 and B6 are connected to a cathode of a transient voltage suppressor (TVS) D38. A micro resistor R82 is connected in series between an anode of the transient voltage suppressor D38 and the grounding point. In addition, the anode of the transient voltage suppressor D38 is further connected to one end of a resistor R81.

The common-mode filtering unit on the fourth pair of transmission lines is a common-mode filter T18, which is connected in series to the fourth pair of transmission lines. One end of two coils of the common-mode filter T18 is respectively connected to the second connection ends 27 and 28, and the other end of the two coils of the common-mode filter T18 is respectively connected to input ends of rectifier bridges B7 and B8. Output ends of the rectifier bridges B7 and B8 are connected to a cathode of a transient voltage suppressor (TVS) D37. A micro resistor R79 is connected in series between an anode of the transient voltage suppressor D37 and the grounding point. In addition, the anode of the transient voltage suppressor D37 is further connected to one end of a resistor R80.

The input ends of the rectifier bridge B1 and the rectifier bridge B3 are connected, the input ends of the rectifier bridge B2 and the rectifier bridge B4 are connected, the input ends of the rectifier bridge B5 and the rectifier bridge B7 are connected, and the input ends of the rectifier bridge B6 and the rectifier bridge B8 are connected. The transient voltage suppressor D36 on the first pair of transmission lines is connected in parallel to the transient voltage suppressor D31 on the second pair of transmission lines. The transient voltage suppressor D38 on the third pair of transmission lines is connected in parallel to the transient voltage suppressor D37 on the fourth pair of transmission lines. The other ends of the four resistors R75, R78, R81 and R80 on the four pairs of transmission lines are connected to each other, so that the four transient voltage suppressors D36, D31, D38 and D37 are connected in parallel to each other and to the ground, and have the same potential at the cathodes thereof. That is to say, nodes A, B, C and D shown in FIG. 3 are equipotential points.

A matching unit is further connected in series on each of the transmission lines. A detailed description is given below by taking a first transmission line at the top as an example. On the first transmission line, there is a node serving as an input end of the rectifier bridge B1, and the node is connected to one end of the matching unit. In this preferred embodiment, the matching unit includes a coupling capacitor C74 and a TVS diode D46 having an internal parasitic capacitance. The coupling capacitor C74 is connected in series on the first transmission line. One end of the TVS diode D46 is connected to the first transmission line, and the other end of the TVS diode D46 is grounded. In other embodiments (not shown), the matching unit may be a coupling capacitor and a compensation capacitor. The coupling capacitor is connected in series to the transmission line. One end of the compensation capacitor is connected to the first transmission line, and the other end of the compensation capacitor is grounded. That is, the TVS diode D46 in the above most preferred implementation manner is replaced with a compensation capacitor.

In this embodiment, an attenuation unit is further connected in series on each of the transmission lines at positions adjacent to the first connection ends 11-18, and is used for attenuating the voltage so as to maintain the voltage at a required value. For example, resistors R70 and R71 are respectively connected in series on the two lines of the first pair of transmission lines. One end of the resistors R70 and R71 is respectively connected to the first connection ends 11 and 12. Likewise, the other three pairs of transmission lines are all are provided with resistors at the same positions as those of the resistors R70 and R71 on the first pair of transmission lines.

In a normal working state, the network chip and the RJ45 socket transmit signals to and receive signals from each other through the network signal processing circuit. For example, in the first pair of transmission lines, the common-mode filter T20 is used for suppressing common-mode interference during signal transmission. With the internal parasitic capacitance, the TVS diode D46 in the matching unit can compensate for high frequency response by using its capacitance properties. The coupling capacitor C74 is used for coupling a high frequency signal. The resistor R70 is used for attenuating the voltage so as to maintain the voltage at a required value.

After a lightning signal enters the RJ45 socket from the outside, the lightning signal flows from the second connection ends 21 and 22 into the network signal processing circuit. First, the lightning signal flows through the common-mode filter T20. At this time, magnetic fluxes produced by two chokes of the common-mode filter T20 are in the same direction and added, and the chokes present high impedance, and therefore can attenuate a part of the lightning signal. This is a first-layer lightning protection structure, which can prevent burnout of the transient voltage suppressors in the lightening protection unit. Next, the remaining part of the lightning signal is conducted to the earth through the transient voltage suppressor D36 in the lightening protection unit, which achieves a second-layer lightning protection structure. Then, the TVS diode D46 can further conduct the lightning signal to the earth, which achieves a third-layer lightning protection structure. The signal transmission processes in the other three pairs of transmission lines are the same as that of the first pair of transmission lines, so that the details will not be described herein again.

Due to defects of the manufacturing process, there is a deviation in the breakdown voltage of each transient voltage suppressor, so that the four transient voltage suppressors D36, D31, D38 and D37 may have different breakdown voltages. As the voltage rises in the lightning signal, a transient voltage suppressor having a low breakdown voltage breaks down first. As the voltage further rises, the current increases accordingly, and at this time, since the anodes of the four transient voltage suppressors D36, D31, D38 and D37 are respectively connected to the micro resistors R76, R77, R82 and R79, the potentials of the cathodes of the four transient voltage suppressors D36, D31, D38 and D37 connected in parallel will increase, that is, the potentials of the four nodes A, B, C and D shown in FIG. 3 will increase simultaneously. When the potential reaches the breakdown voltage of another transient voltage suppressor, the transient voltage suppressor reversely breaks down, and the current in the lightning signal is diverted to the ground through the two broken down transient voltage suppressors.

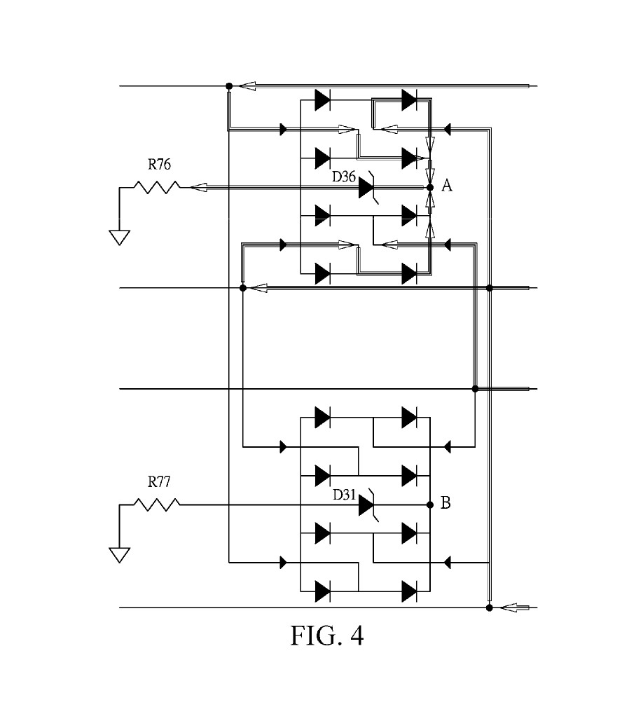

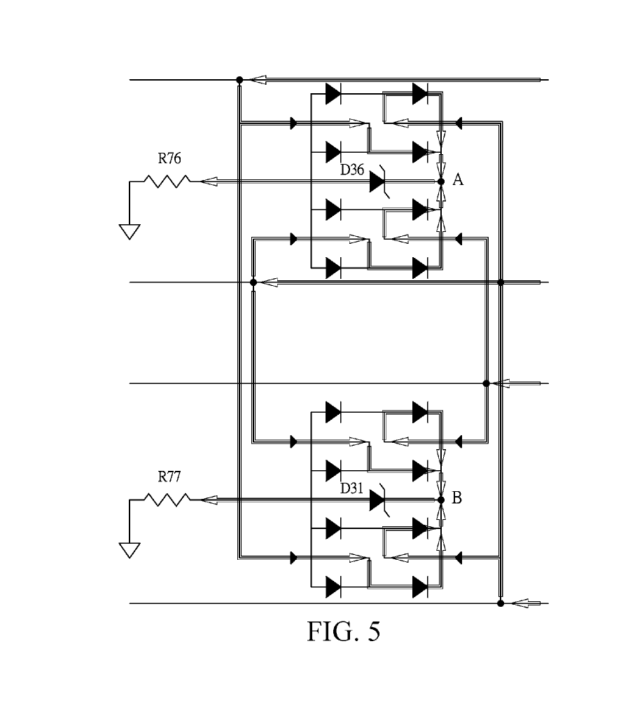

A further detailed description is given below by taking the lightening protection units in the first pair of transmission lines and the second pair of transmission lines as an example. Referring to FIG. 4 and FIG. 5, arrows indicate the flow direction of a lightning current in the circuit. As shown in FIG. 4, when the lightning signal enters the circuit, one of the two transient voltage suppressors D36 and D31 connected in parallel which has a lower breakdown voltage breaks down first. For example, D36 breaks down first. As the voltage further rises, the current increases accordingly, and at this time, the larger the current flowing through the micro resistor R76 is, the large the voltage difference between two ends of the micro resistor R76 is. Since one end of the micro resistor R76 is grounded, this end is a zero potential. Provided that the voltage difference between the two ends of the micro resistor R76 increases, the potential of the other end of the micro resistor R76, that is, the anode of the transient voltage suppressor D36, increases. Likewise, the voltage difference between two ends of the transient voltage suppressor D36 also increases due to resistance properties in the transient voltage suppressor D36, and the potential of the cathode of the transient voltage suppressor D36, that is, the potential of the node A in FIG. 4, increases accordingly. Since A and B are equipotential points, the potential of the node B also starts to increase. When the potential of the node B increases to such an extent that the voltage at two ends of the transient voltage suppressor D31 is equal to or greater than the breakdown voltage of the transient voltage suppressor D31, the transient voltage suppressor D31 reversely breaks down, and an overcurrent in the lightning signal is diverted to the earth through the two transient voltage suppressors D36 and D31 connected in parallel, as shown in FIG. 5. This can prevent the transient voltage suppressor D36 that breaks down first from burning out due to the overcurrent, thereby ensuring the stability and durability of the transient voltage suppressor.

The resistance of the micro resistor may be obtained in the following manner. Assuming that the transient voltage suppressor has a breakdown voltage Vt1, a maximum breakdown current IPP and a withstand current I1, then the value of the micro resistor is calculated as R=Vt1/I1. For example, parameters of the selected transient voltage suppressor R76 are: the breakdown voltage Vt1 being 3-4.5 V, the maximum breakdown current IPP being 40 A, and the withstand current I1 being 30 A. When the current flowing through the transient voltage suppressor D36 reaches the withstand value of 30 A, the transient voltage suppressor D31 needs to be used for current diversion. In this case, a micro resistor R76 may be connected in series to the anode of the transient voltage suppressor D36, where the resistance of the micro resistor R76 is 0.15 ohm (4.5 V/30 A=0.15 ohm).

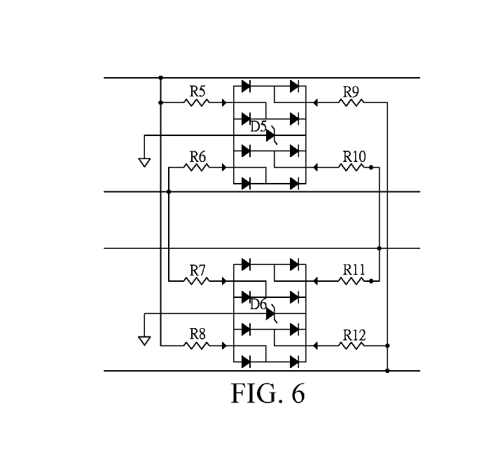

FIG. 6 shows another method for connecting the micro resistors according to a third embodiment of the present invention. Since other elements and connection relationships of the elements in this embodiment are the same as those in the first embodiment, only some elements and connection relationships thereof are illustrated in this embodiment. In this embodiment, micro resistors R5 and R6 are connected in series before an input end of a rectifier bridge, that is, the current flows through the micro resistors R5 and R6 before flowing to the input end of the rectifier bridge, and after being rectified by the rectifier bridge, the current is output to a cathode of a transient voltage suppressor D5. Likewise, micro resistors R7 and R8 are also connected in series before a transient voltage suppressor D6. The current diversion principle of this embodiment is the same as those of the first embodiment and the second embodiment, and diversion of the overcurrent in the lightning signal through the two transient voltage suppressors connected in parallel as described in the first embodiment can also be achieved, thereby preventing the transient voltage suppressor that breaks down first from burning out due to the overcurrent.

The foregoing description of the exemplary embodiments of the invention has been presented only for the purposes of illustration and description and is not intended to be exhaustive or to limit the invention to the precise forms disclosed. Many modifications and variations are possible in light of the above teaching.

The embodiments are chosen and described in order to explain the principles of the invention and their practical application so as to activate others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A network signal processing circuit, comprising:
at least one transmission line, having a first connection end and a second connection end; and
at least two transient voltage suppressors, each of the transient voltage suppressors being connected between a grounding point and a node on the at least one transmission line, two of the transient voltage suppressors being connected in parallel, and a micro resistor being connected in series on the line where each of the transient voltage suppressors is located.

2. The network signal processing circuit according to claim 1, wherein the micro resistor is connected in series between an anode of the transient voltage suppressor and the grounding point.

3. The network signal processing circuit according to claim 1, wherein the micro resistor is connected in series between a cathode of the transient voltage suppressor and the node.

4. The network signal processing circuit according to claim 1, wherein the network signal processing circuit comprises more than one pair of the transmission lines, a common-mode filtering unit being further connected in series to each pair of the transmission lines, one end of the common-mode filtering unit being connected to the second connection end, and the other end of the common-mode filtering unit being connected to the node.

5. The network signal processing circuit according to claim 4, wherein an attenuation unit is further connected in series to each of the transmission lines at a position adjacent to the first connection end.

6. The network signal processing circuit according to claim 5, wherein the attenuation unit is a resistor.

7. The network signal processing circuit according to claim 4, wherein a matching unit is further connected in series to each of the transmission lines at a position adjacent to the first connection end, the matching unit comprising a coupling capacitor and a transient voltage suppressor (TVS) diode having an internal parasitic capacitance, the coupling capacitor being connected in series between the node and the attenuation unit, one end of the TVS diode being connected to the transmission line, and the other end of the TVS diode being grounded.

8. The network signal processing circuit according to claim 4, wherein a matching unit is further connected in series to each of the transmission lines at a position adjacent to the first connection end, the matching unit comprising a coupling capacitor and a compensation capacitor, the coupling capacitor being connected in series between the node and the attenuation unit, and two ends of the compensation capacitor being respectively connected to the transmission line and the grounding point.

9. The network signal processing circuit according to claim 1, wherein the first connection end is connected to a network chip, and the second connection end is connected to an RJ45 socket.

10. The network signal processing circuit according to claim 1, wherein a rectifier bridge is further connected between a cathode of each of the transient voltage suppressors and the node.
